(19) United States
(12) Patent Application Publication
(10) Pub. No.: US 2009/0138472 A1
(43) Pub. Date: May 28, 2009

(54) Method of Supplying Information Articles at a Website and a System for Supplying Such Articles

(75) Inventor: Ian Kenneth MacLean, West Midlands (GB)

Correspondence Address: KENYON & KENYON LLP, ONE BROADWAY, NEW YORK, NY, 10004, US

(73) Assignee: WINE SCIENCE LTD.

(21) Appl. No.: 11/887,706

(22) PCT Filed: Apr. 3, 2006
(86) PCT No.: PCT/GB2006/001230

§ 371 Date: Oct. 1, 2007

(30) Foreign Application Priority Data
Apr. 1, 2005 (GB) 0506618.8

(51) Int. Cl. G06F 17/30

(52) U.S. Cl. 707/7; 707/E17.008

(57) ABSTRACT

System (1) provides information articles specifically targeted to particular subject matters. A datastream (2) of information, typically discrete articles is output from the internet (3) and processed in a filter operation (4) to select only those items which are relevant to a particular subject area. The resultant articles are published at a website (5) accessible by users (6) who subscribe to the service. When a user (6) enters the website, his activities while on the website are monitored, particularly by noting the articles that he views, and the inspection time taken for an article. The user's activities are used for determining the rank of displayed articles.

The present invention relates to a method of retrieving information articles and supplying them at a website, and a system for supplying such information articles.

### BACKGROUND OF THE INVENTION

Systems are known which involve filtering data streams of information and published articles into those which are of particular relevance in a given subject, and there are proposals and attempts at directing such searching to specific individuals' interests.

International Patent Publication WO 02/41182 discloses a system which involves accessing a customer's history of use held on a database.

US Patent Application Publication No. 2002/0062341 describes a news item distributing system which retrieves news items of specific interest to a given subscriber and based on the user's access history.

However, these conventional systems are limited in their capability of selecting and presenting articles to new and existing users based on historical aggregated user behaviour.

### SUMMARY OF THE INVENTION

According to the present invention, there is provided a method of providing, at a website, articles about a subject, the method comprising:
compiling a number of articles about a subject for viewing at a website; and
applying a ranking operation on the articles with the ranking value being determined by website visitor actions.

In this way, the method of the invention may ensure that the relevance of the documents retrieved is continuously refined towards the user's interests.

### OBJECTS OF THE INVENTION

An object of the present invention may be to provide an information retrieval and supply service which is particularly suited to a specific interest of a customer.

Another object of the present invention may be to provide an information retrieval and supply service which is particularly suited to a variety of interests of the specific user.

Another object of the present invention may be to provide a service which is dynamic in continually refining the search and analysis of relevant information articles.

The method of the present invention may include any one or more of the following preferred features:—
A ranking value of an article is modified by interactions between a website visitor or visitors and the website;
A ranking value of an article is increased by a website visitor clicking on and/or viewing the article;
A ranking value of an article is increased in relation to the time duration for which a website visitor views the article;
A ranking value of an article is increased by a print operation in relation to that article;
A ranking value is determined according to time spent on viewing an article, with a normalisation factor based on one or more of the following characteristics:—
   The size of articles;
   The number of words in the article;
   The number and/or size of tables and/or Figures in the article;
   A complexity co-efficient related to the article.
Delivery of the article to a user actions a clock to note the time spent viewing the article;
A next instruction subsequent to the delivery terminates the clock;
the next instruction comprises at least one of the following actions:—
   Return to the website;
   Viewing of a new article;
   Departure from the website.
the website sends regularly an instruction to check the user is still viewing the article.
if the website notes the user is not viewing the article, a clock for noting viewing of that article is terminated.
the article to be viewed is opened in a subsection of the website for viewing.
the ranking operation further includes applying an increased rating in respect of an article, for one or more of the following elements:
   The article is hosted by the website;
   The article is from a pre-selected channel;
   The article has a pre-selected keyword in the summary, headline, and/or URL;
   The publication date of the article.
   checking that the article is the most recent version available on the Internet.
modifying the ranking of articles in accordance with any one or more of the following actions:—
   introduction of an article new to the website;
   deletion of an article from the website;
   re-categorisation of an article.

Another aspect of the present invention comprises a method of supplying a newsletter comprising:
compiling a number of articles about a subject at a website;
applying a ranking operation on the articles with a ranking value being determined by website visitor actions;
electronically sending out a newsletter, on the Internet or other electronic network or communication system, the newsletter including articles or summaries sorted according to the ranking value.

The method may comprise the method of providing articles at a website of the present invention. In the method of this aspect of the invention, the website visitor actions comprise website actions of the user for whom the newsletter is being provided, thereby to provide a newsletter customised to that user's specific interests.

According to the present invention, there is also provided a computer program product directly loadable into the internal memory of a digital computer, comprising software code portions for performing the method of the present invention when said product is run on a computer.

According to the present invention, there is also provided a computer program directly loadable into the internal memory of a digital computer, comprising software code portions for performing the method of the present invention when said program is run on a computer.

According to the present invention, there is also provided a carrier, which may comprise electronic signals, for a computer program embodying the present invention.

According to the present invention, there is also provided electronic distribution of a computer program, or a carrier of the present invention.

According to the present invention, there is provided a website with a plurality of articles selected and/or ranked according to the present invention.

According to the present invention, there is also provided a system for providing, at a website, articles about a subject, the system comprising:
means to compile a number of articles about a subject for viewing at a website; and
means to apply a ranking operation on the articles, the ranking value being determined by website visit or actions.

The system may include any one or more of the following preferred features:—
means to modify the ranking value of an article by interactions between a website visitor and the website.
means to increase the ranking value of an article by a website visitor clicking on and/or viewing the article.
means to increase the ranking value of an article due to a print operation in relation to that article.
means to increase the ranking value of an article in relation to the time duration for which a website visitor views the article.
means to operate the ranking means according to the time spent on viewing each article, with a normalisation factor based on one or more of the following characteristics:—
   The size of the article;
   The number of words in the article;
   The number and/or size of tables and/or Figures in the article;
   A complexity co-efficient related to the article.
a clock, operable on delivery of the article to a user, to note the time spent viewing the article.
means to operate the clock to terminate upon a next instruction subsequent to the delivery.
The next instruction comprises at least one of the following actions:—
   Return to the website;
   Viewing a new article;
   Departure from the website.
means to operate the website to send regularly an instruction to check the user is still viewing the article.
means, if the website notes the user is not viewing the article, to operate a clock for noting viewing of that article is terminated.
means to open an article to be viewed in a subsection of the website for viewing, for determining time spent viewing.
the ranking means is operable to apply an increased rating in respect of an article for one or more of the following elements:
   The article is hosted by the website;
   The article is from a pre-selected channel;
   The article has a pre-selected keyword in the summary, headline, and/or URL;
   The publication date of the article.
means to check that the article is the most recent version available on the Internet.

Another aspect of the present invention comprises a system for supplying a newsletter comprising:—
means to compile a number of articles about a subject at a website;
means to apply a ranking operation on the articles, the ranking value being determined by website visit or actions;
means to electronically send out a newsletter, on the Internet or other electronic network or communication system, the newsletter including articles or summaries sorted according to the ranking value.

This aspect of the present invention may comprise a system for providing articles at a website of the present invention. In the system, the website visitor actions may comprise website actions of the user for whom the newsletter is being provided, thereby to provide a newsletter customised to the user's interests.

### ADVANTAGES OF THE PRESENT INVENTION

The present invention as described herein may provide the following advantages:
Minimised need for human editorial intervention;
Constant evaluating of changing interests of a target audience;
Time-to-publish minimised;
Always-on, 24 hours a day coverage;
User satisfaction maximised through self-reinforcing content targeting;
Applicability to textual information in any subject area given some setup work.
the development of a collection of articles or a distributed newsletter which is customised to the user's interests, and available for access at the website and/or sent to the user at specified intervals.

### APPLICATIONS OF THE PRESENT INVENTION

The present invention is applicable to providing articles at a website, and also supplying to people (especially subscribers) a newsletter incorporating articles suitably ranked in relation to website activity, including viewing and printing. That website activity is based on activity of all visitors to the website, and/or on specified groups of visitors, and/or on the visitor for which a customised set of articles is available at the website or sent in a newsletter to that visitor.

The present invention is directed to a ranking operation, with automated up-dating capability, in relation to articles (typically newspaper and magazine articles and documents) being blocks of word-text information and data. However, the present invention is further directed to such operation with other forms of blocks of data and information, for example for identifying and ranking music.

While the present invention is directed principally to the ranking of articles at a website, it is also applicable to the ranking of data blocks at a database or other collection of data and information.

The present invention involves the distribution of articles and/or newsletters over the Internet and other equivalent or similar electronic networks or communication systems.

### GENERAL DESCRIPTION OF THE PRESENT INVENTION

In order that the present invention may more readily be understood, a description is now given, by way of example only, reference being made to the accompanying drawings, in which:—

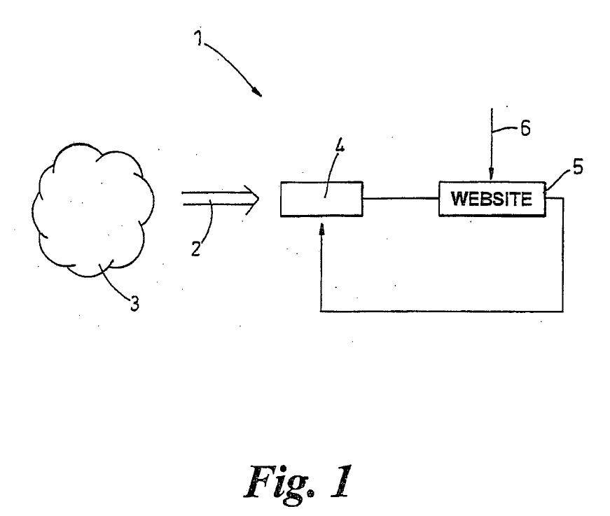

FIG. 1 is a general schematic diagram of a system embodying the present invention;

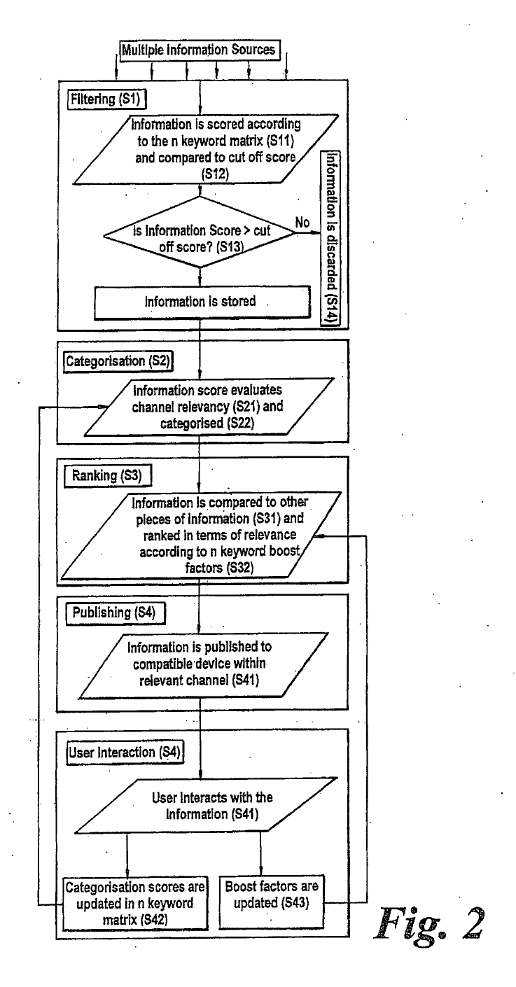

FIG. 2 is a flow diagram of operation of a system embodying the present invention;

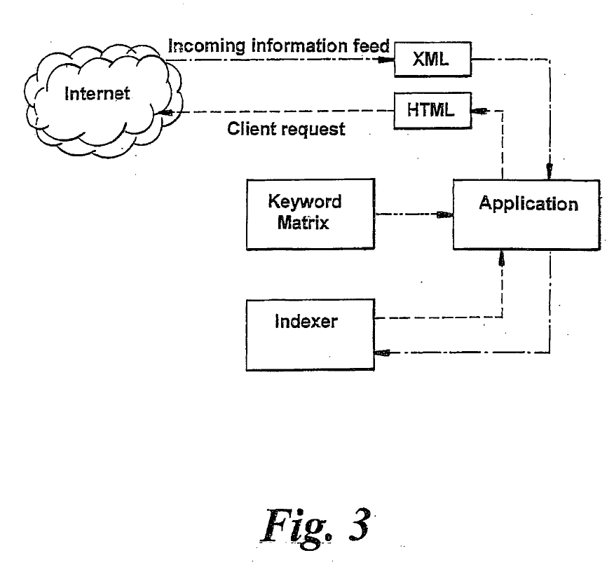

FIG. 3 shows the system architecture of the system of FIG. 2; and

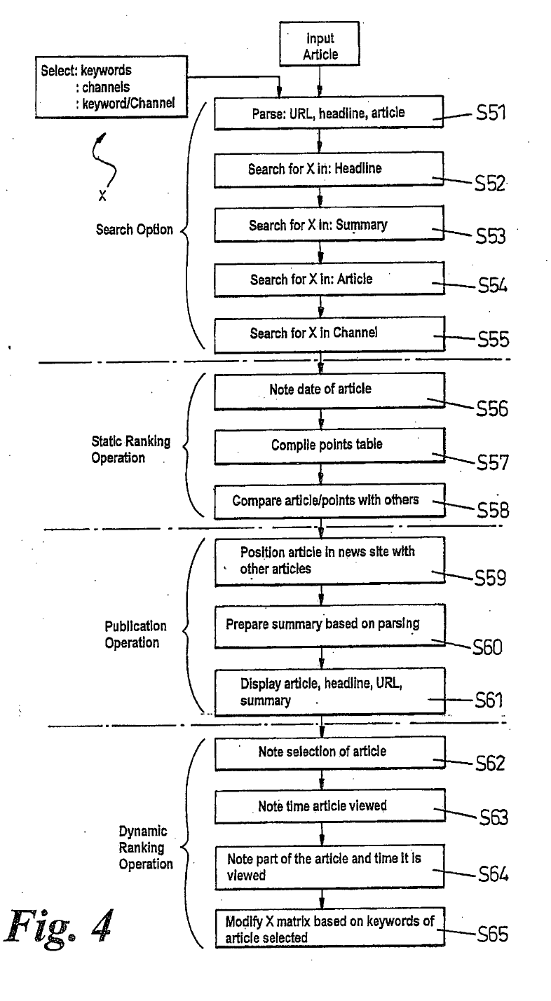

FIG. 4 is a flow diagram of operation of a second embodiment of the present invention;

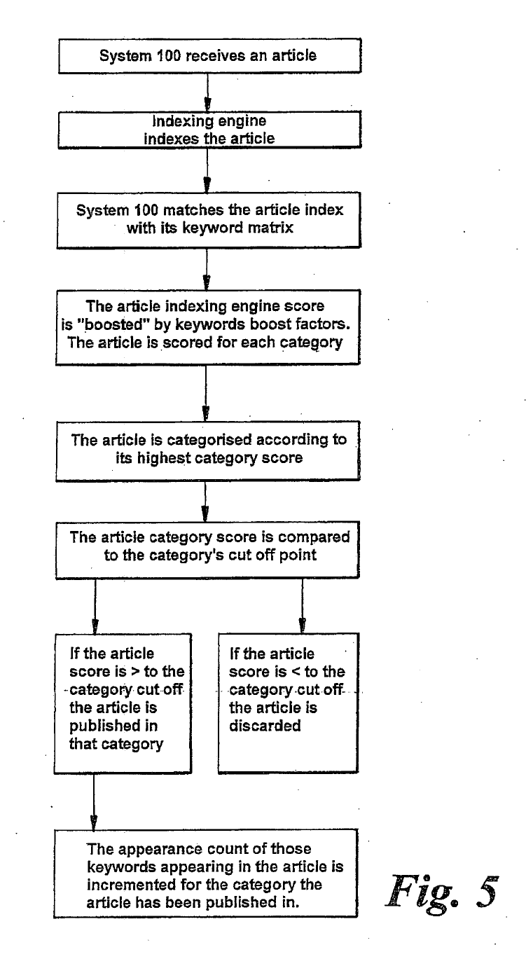

FIG. 5 is a flow diagram of operation of a third embodiment of the present invention;

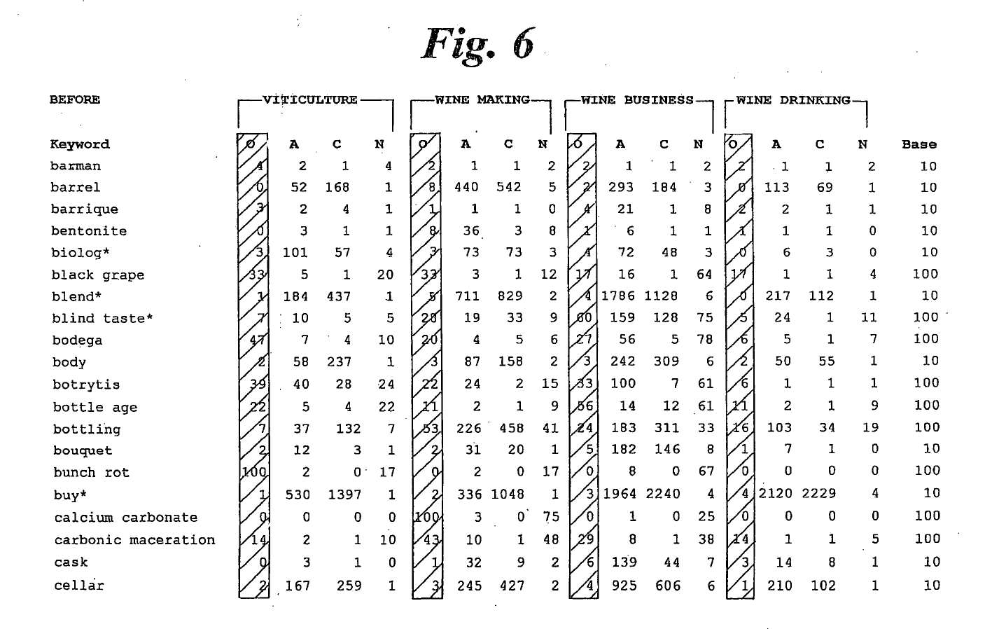

FIG. 6 is a spreadsheet with a “before an O score update”;

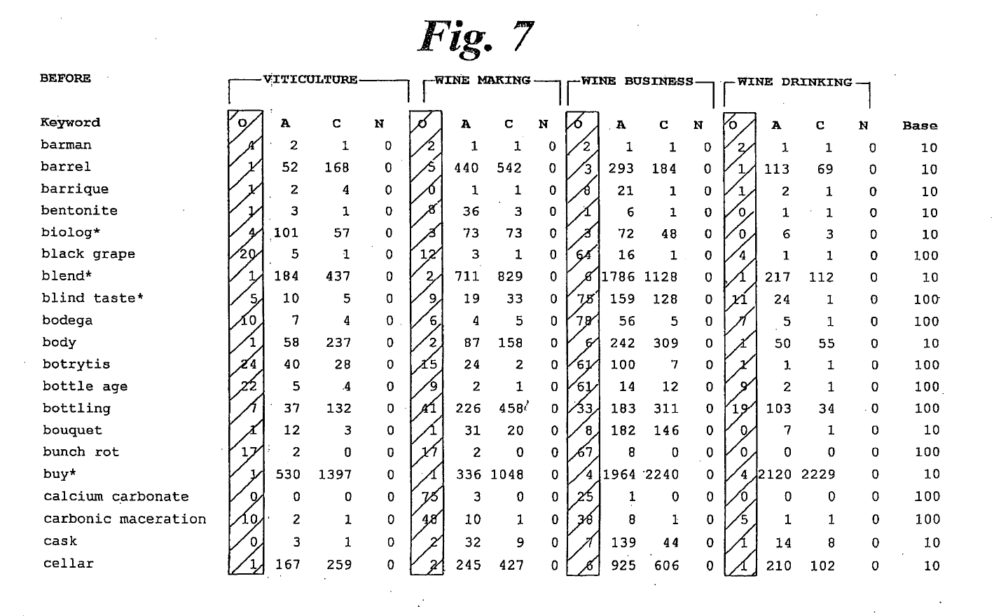

FIG. 7 is the spreadsheet of FIG. 6 with an “after an O score update”.

FIG. 1 shows a block schematic diagram illustrating in general terms a system 1 of the present invention for the provision of information articles specifically targeted to particular subject matters. These information articles may be periodicals and magazines which are publicly available in electronic format, whether or not they were originally or previously published in printed-material form.

A datastream 2 of information, typically discrete articles (but including any suitable form of information), is output from the internet 3 and processed in a filter operation 4 to select only those items which are relevant to a particular subject area.

The resultant articles are published at a website 5 accessible by users 6 who subscribe to the service. When a user 6 enters the website, his activities while on the website are monitored, particularly by noting the articles that he views, and the inspection time taken for an article. Also note is taken of any searching he is involved in during his visit to the website, together with the searching terms used and the results.

Also this information on his behaviour and activity is fed back into the filter operation 4 in order to modify the criteria used in the filter operation in accordance with the actions of the user 6. In this way, the filter operation is continually refined in order to ensure that it is tuned to the required interests, so the articles available on website 5 are only those which are truly relevant to the user's requirements.

Various aspects of the operation will now be described in greater detail.

The filtering operation 4 incorporates a number of steps.

Firstly, the datastream 2 from the internet is limited to information in the subject-matter area of wine. This could be done in various ways, for example, by regulating the content feed into the site (typically by selection of the provider eg NewsNow.com) or by coarse filtering of the content material, or by combining input from a number of single-interest sources. The content feed could be of any appropriate form, eg it could be a combination of feeds from various sites (eg that could have been set up individually eg of a specialist nature or of a highly-defined subject-matter).

Within a website, a number of sub-section are created that refer to mutually exclusive and discrete topics (but in a variant, some topics may overlap). In the example of Wine, the sub-sections are “Viticulture”, “Wine Business”, “Wine Making” and “Wine Drinking”.

Then the editor selects a set of keywords composed of words or terms relating to the subject matter and commonly used in articles concerning the topic of interest, in this example “Wine”.

For each keyword, the human editor assigns a probability factor of the likelihood of an article which contains that keyword actually being relevant to each sub-section of the site. For example, if the keyword was “Yeast”, the probability factor might be 70% for sub-section 3, in that it would be more likely that a given article referring to “Yeast” would be relevant to the sub-section of the site.

The matrix of keywords and sub-sections is shown in Table 1.

TABLE 1

| | Sub- | Sub- | Sub- | Sub- |
|---|---|---|---|---|
| | section 1 | section 2 | section 3 | section 4 |
| | “Viti- | “Wine | “Wine | “Wind |
| Keywords | culture” | business” | Making” | Drinking |
| Wine | 25 | 25 | 25 | 25 |
| Grape | 70 | 10 | 0 | 20 |
| Merlot | 30 | 20 | 50 | 0 |
| Viticulture | 100 | 0 | 0 | 0 |
| Yeast | 10 | 10 | 70 | 0 |

Thus, from the keyword matrix is produced a categorisation of each article.

Thus, there is produced a filtering and categorisation of articles based on keywords and probabilities.

The categorisation processes is the result of the assignment of a categorisation score, (see Table 2) to each article. The scoring of articles is achieved by taking the sum of the probabilities of all the keywords appearing in the article, and multiplying each by the number of appearances of each keyword within that article. That sum is compared across categories. The system will automatically decide on the categorisation of an article by selecting the category score that is the highest.

Once an article has been categorised, its score in that category is compared to a cut-off point that will have been defined by a human editor. If its score in that category is superior to the cut-off score, then the article will be published on the website 5. Else the article will be discarded as not relevant enough to the topic area in general to be published.

Table 2 below illustrates the possible scoring result for Article 1 that contains the words “Wine”, “Grape”, “Merlot”, “Yeast” once and “Viticulture” twice

TABLE 2
Article 1

| | | Points | Points | Points | Point |
|---|---|---|---|---|---|
| Keyword | Occurrence | for SS1 | for SS2 | for SS3 | for SS4 |
| Wine | 1 | 25 | 25 | 25 | 25 |
| Grape | 1 | 70 | 10 | 0 | 0 |
| Merlot | 1 | 30 | 20 | 50 | 0 |
| Viticulture | 2 | 200 | 0 | 0 | 0 |
| Yeast | 1 | 80 | 10 | 10 | 0 |

| | | | | |
|---|---|---|---|---|
| Cat. Score Total | 405 | 65 | 85 | 25 |

If the cut-off point for category 1 had been set by the human editor to 300, then the article 1 would be published on the site.

As a final step in the process, articles are ranked against each other. Once a group of articles are published on website 5, the activities of any visitor to the website are monitored in order to note which articles are viewed and for how long they are viewed (both in absolute terms and normalised to take into account size, complexity and format of the content). There are various additional features that can be used to enhance the ranking of an article as part of the dynamic ranking of that article. Such features include:
The source of the article;
The geographic relevance of the articles;
The subject area of an article;
When the article has been published i.e. its age.

The ranking procedure is further boosted by the existence within an article of one or more instances of keywords contained by the keyword matrix. In this case, the ranking score of an article will be boosted by a factor obtained by adding the products of all keywords appearing in the article by the number of clicks that particular article has experienced on the site. Thus the ranking mechanism is affected not only by user interaction but also by the article's contents.

For example, if an article contained the word “Viticulture”, and that keyword appeared 5 times. And, if that article had been visited 10 times, the ranking of that article would be boosted by a factor of 5,000 (probability score) times 5 (instances) times 10 (visits).

Furthermore, in addition to being self-generating, the system is also self-correcting. Included in the system is a mechanism that will update the original keyword matrix that had been set up by a human editor in order to remove any subjectivity in establishing relevancy scores.

For example, in Table 2 above the word “Viticulture” has original relevance categorisation scores of 100,0,0,0. If the keyword “Viticulture” was the only keyword appearing in the article, then the article would be categorised in sub-section 1. However since each article typically contains more than one keyword, categorisation will depend on the relative weighting of each keyword and on the number of appearances they make. Reality therefore is that over time the keyword “Viticulture” might appear in articles that are categorised under other sub-sections. At regular intervals, the total number of appearances of a keyword in a particular section is evaluated against the total number of appearances of that keyword across the whole site and normalised to base 100 or base 10, to compute new sub-section relevance probability scores. If for example, the keyword “Viticulture” has appeared in total 20 times, according to the following distribution across sub-categories 5, 10, 2, 3, an update to the relevance probability for that keyword under each subcategory would be calculated as:

RP{ss1,new}=A{ss1}/TA*100 or 10

Where:
RP {ss1,new} is a keywords new relevance probability score for sub-section 1.
A{ss1} is a keywords appearances in category ss1.
TA is a keywords total appearances across all sub-sections.

Therefore for each keyword, new sub-section relevance probabilities can be calculated and updated, thus correcting the original keyword matrix over time.

### DETAILED IMPLEMENTATION

Incoming information contained in data stream 2 is delivered to system 10 from various sources in the internet in a variety of proprietary and open formats, and is processed into the XML format and converted into articles.

Details of the originating website of the article and the textual abstract are parsed in the HTML format, with removal of data not relevant to the topic of interest. This textual abstract is later used to check relevance to the website and its according ranking.

The processing operation uses the keyword matrix and pattern matching techniques to determine relevant keywords in the article and match them against the matrix in order to categorise the article according to the topic of interest. Then the processing operation adds up the scores of all the keywords and determines the article's relevance based on the categorisation score.

After scoring the article, the application makes a decision on whether to discard this article based on its categorisation score. For example, the articles with the 10 highest scores may be used or, if the score from the highest classification is lower than the value set by the editor, then the article is discarded and never published.

The website may have many channels, each for a topic, and so an article from data stream 2 may be reviewed to determine into which of the channels it is to go. A given article may be included in a number of channels, according to its relevance to the appropriate topics.

A channel may be based on a topic and accessible to any subscriber user. Alternatively, a channel may be directed to a specific subscriber user, and accessible only to that user; again, it can be topic-specific for that user, or it can be directed to a variety of topics of interest to the user.

The resulting articles are then checked against the existing index, and previously indexed articles are discarded. Otherwise they are stored in the index for publication and later retrieval and ranking.

When a user visits the website, accesses a channel and requests a set of articles, such as that appearing on the default page, the application performs a query on the index based on a keyword matrix created by the editors. The keyword matrix includes a set of words that are of interest to the website and their relevant scores in each categorisation. The application uses these scores to determine the most relevant articles in the index user. The application also applies other logic to the query, such as categorisation filtering and time filtering where we query the index for articles indexed in a specified time range.

The index returns a list ranked based on its internal ranking algorithms. The resulting article set is sent to a template where it is parsed into the HTML format readable by web browsers.

The system comprises a server or cluster of servers running the following software:
Unix
Java
Java Application Server
Indexer
Webserver

The keyword matrix has been given a categorisation score in each channel by an editor based on their perception of the relevance of the keyword. When a user clicks on article to view its content, the application takes the keyword from the article that has a match in the keyword matrix and increments the clicked field in the keyword matrix.

This information, along with other gathered logic such as the original source, is fed back into the keyword matrix to affect subsequent scoring and ranking of articles.

This leads to a system where the information published is constantly evolving and being refined to the user's interests, allowing the application to sustain itself without editorial input.

Operation of the automated customised news retrieval and delivery system 20 for a second embodiment of the present invention is described with reference to the flow diagram of FIG. 4, and based on the provision of news items and information related to “Wine”.

Thus, in order to establish the system, an operator selects a list of keywords and relevance probability factors as described previously and inputs them into the Search Matrix X.

The operator inputs to system 20 news content from a standard news content provider in the form of a number of news articles in the general area of wine-making, for example each article being processed as follows.

The article is parsed in Step S51 and its constituent parts are searched according to headline (S52), summary (S53), the entire article (S54) and channel (S55), in order that a points table is then compiled (Step S57) based on the frequency of appearance in the text of the keywords of Matrix X.

The points table also includes a note of the publication date of the news article (Step S56).

At Step S58, a comparison is made between the points awarded to the news article and those points of the existing articles, in order to position the articles suitably on the website display (Step S57). Thus, the highest-ranked, most recently published content is displayed at the top of the web page, and thereafter they are positioned in descending order of relevance and publication date. Accordingly, a given article is moved down as more-recently published or higher-ranking articles come into the system.

A number of articles may be ordered according to how recent they are and/or according to their degree of relevance.

The relevance is the result of a number calculations made eg by the hierarchy of elements that affect the relevance of an article is typically:—
Structure of the article, number of words, location of words in the text, etc (this results in an indexing engine index score);
The indexing engine index score is then affected by the age of the article (boosted negatively);
The indexing engine index score is further “boosted” by the keyword category scores;
The indexing engine index is further boosted by the user interaction with the site including click through on an article and the time the user spends reading and article.
The indexing engine index can be further boosted by the source of the article, and can be boosted by a number of other factors.

At Step S60, a customised abstract is prepared based on the parsing at Step S51; then this abstract, together with the headline and URL originally from the new content provider, is displayed on the website (Step S61).

System 60 tracks the activity of a user on the website, noting any article viewed by the user (Step S62) and the length of time which that user spends viewing that article (Step S63), additionally the part of the article, or the headline or the URL (Step 64).

In order to time the viewing of the article content, when the appropriate content is delivered to the user, a clock is activated and remains operating until a subsequent instruction is made, for example in the form of a request to return to the main portion of the website, or a request to view another article or part thereof, or a request to depart the website, or a request to print the document.

Additionally or alternatively, the website sends regularly an instruction to check whether the user is still viewing the article.

Step 65 modifies the Matrix X in accordance with the Steps 62-64 activity and then this modified form of Matrix X is used in Step S61 for a newly introduced article, and also in Step S67 for this or another already-processed article.

In this way, the importance of the most popular keywords, is boosted, leading to changes in article ranking.

Also, this ranking process allows the system to filter the news feed down to only the content that is most relevant to the subject area to which the system is targeted (in this case wine-making). The only human editorial input that is required in this system is the creation of this keyword matrix.

Also, the search terms used for the articles are added to the Matrix X. The Matrix X has a filter to remove keywords which have a consistently very low-ranking even after a significant number of cycles of the flow operation, in order to eliminate those words which are not relevant.

Thus the content of the website is constantly refocused around what the users want.

Not only does system 20 target and filter content at a system level based on user activity, it also does it at the user level. System 20 builds up a history for each user of what content interests them, and specifically targets appropriate content at them. Over time, this self-reinforcing cycle means that the user experiences a very high level of satisfaction as they get to view a page which is truly produced just for them and which they will find highly relevant.

Advantages of system 20 include:—
Need for intervention by human editors minimized;
Time-to-publish minimized;
Always-on, 24 hours a day coverage;
User satisfaction maximised through self-reinforcing content targeting;
Applicability to any subject area given some setup work.

FIG. 5 shows a further system 100 which operates as follows:—

### 1. System 100 Basic Evaluation Procedure

1. Articles, or any other form of text-based content is fed into the system 100 either automatically (through RSS feeds or by hand (editorial).
2. An indexing engine natively analyses text-based content and evaluates internally (or scores) that content. The indexing engine is natively able to evaluate different pieces of text against each other.
3. System 100 uses the indexing engine index for a particular article to evaluate the appearance of a number of pre-selected keywords or keyphrases contained in the system's keyword matrix.
4. If a keyword or keyphrase is found, the internal indexing engine article score is boosted by that keyword's boost factor. System 100 does this for:
   a. All keywords/keyphrases found in the article
   b. All categories defined through the system.
5. System 100 evaluates the article scores across the different categories defined and categorises the article according to the highest score.
6. System 100 evaluates the article score in the category against that category's cut-off point:
   a. If the article score is below the category cut-off point, then the article is not published on the system and the article is discarded and flushed from the system, being considered “not relevant enough”.
   b. If the article score is above the category cut-off point, then the article is deemed “relevant” and is published on the system.
7. As an article is first published within a category, the “appearance” count of those keywords/keyphrases it contains is incremented by the number of time they appear in the article.

### 2. Effect of Editorial Intervention

A site editor evaluates the results of system 100 and either by reviewing some or all articles scored and/or published affects the publishing of articles by deleting or re-categorising an article.

### Article Deletion

The site editor might consider that an article that has been published by the System is in fact irrelevant to the site as a whole. He then deletes the article:—
1. Editor deletes an article.
2. System 100 evaluates the keywords/keyphrases within the article also contained in the keyword matrix.
3. For those matched keywords, system 100 subtracts, from their appearance count, the number of appearances within the article.

### Re-Categorisation

The site editor might consider that an article that has been published within a given category by system 100 should have been categorised differently. The system then moves that article across categories:—
1. Editor re-categorises an article.
2. System 100 evaluates the keyword/keyphrases within the article also contained in the keyword matrix.
3. For those matched keywords, system 100 subtracts from their appearance count in the original category and categories and adds them to the new category or categories.

### Effect of Editorial

By editing the site and moving articles, the editor affects the appearance count variable in the keyword matrix. This appearance count is category-specific as System 100 evaluates appearances by category. The appearance count is used to evaluate a keyword relevancy rate across categories; by editing articles, the editor affects those relevancy rates and therefore affects the scoring of future articles received.

### 3. Effect of Site User Interaction

A user of the site affects the overall site as he/she clicks through to read published articles:—
1. User clicks on an article.
2. System 100 evaluates the keywords/keyphrases contained in the article that match with those contained in the keyword matrix.
3. For those keywords/keyphrases that are matched, the system increments the click count for those keywords within that category.

Click count is used in conjunction with appearance count above to evaluate the relevancy of a keyword/keyphrase within a particular category. Any click on an article within a category confirms that article's relevancy to that category and increments the click count of the keywords/keyphrases contained within the article. By incrementing the click rate, the user affects that keyword/keyphrase relevancy to the category and affects the scoring of future articles received. System 100 notes the length of time spent in reading the article, and/or whether a print command is activated in order to print a copy of the article, with appropriate scoring or modification of the ranking being done.

### Recording of Time on Website/Article

When an individual clicks on an article, the article opens in a “sub-section” of the site based on frame or new window technology. This allows the system to calculate the amount of time a user spends on a selected article and this is fed into the system to calculate the relevancy of those keywords that are included in the article that has been read. The longer the user spends on the article, the more relevant the article are to the category and to the user's interest and therefore the more relevant those keywords included in the article are to the category and to the user's interest.

### Benefit of New Articles Having a Retrospectively-Generated Scoring History:

Systems 20 and 100 solve the issue of ranking a newly-received article based on user interest. In typical conventional systems, an article's relevancy to an audience or to an interest is based solely on its own historical click count: the more clicks an article receives, the more it is considered to be interesting and therefore the higher it will be ranked. A new article in such a system starts off with a zero count and is dependent on an article receiving clicks in the first instance.

However, systems 20 and 100 evaluate articles based on the keywords they contain and the importance of those keywords relative to each other and their historical relevance, not merely the historical number of clicks received by that article alone.

If a group of users is interested in a particular topic, this interest is recorded by keywords contained in relevant articles rising in rankings. When a new article on the same topic is received, it is evaluated against the keywords which, by ranking higher, will result in a higher ranking of the article compared to other articles received at the same time. As a result, the system publishes the article more prominently, without human editorial intervention.

### Updating on Matrix O Scores

Keyword probability scores, which govern a keyword's probability of appearing in an article within a given category, can be updated either manually or automatically at intervals defined by the system's administrator. The algorithm used to update those scores multiplies the total number of times a keyword has appeared in a given category by the number of times a that keyword has been clicked (i.e. the article containing that keyword has been clicked). Because probability scores across categories are either evaluated on base 100 (i.e. %) or base 10, this is then divided by the total number of times the keyword has appeared across all categories multiplied by the number of times the keyword has been clicked across categories and then multiplied by 100 or 10 depending on the keyword's original base.

### 4. Updating the Keyword Matrix

The keyword matrix can be manually or automatically updated with new relevancy scores for each keyword/keyphrases. As editors and users interact with the site as per sections 2 and 3 above, system 100 reevaluates keyword/keyphrases relevancy scores using appearance and click counts. New relevancy scores for each keyword across categories are then used to update existing relevancy scores.

### Implications:

1. As the number of users on the site increases, click count has, proportionally, a higher impact on relevancy scores compared to editorial intervention.
2. Given implication 1 above, users evaluate the relevancy of an article and therefore the keyword that article contains to a particular category. Over time, the most relevant keywords within a category are ranked higher than less relevant keywords in that category (evaluated by click count multiplied by appearance count).
3. Given implications 1 and 2 above, over time, as user interests change, the list of most relevant keywords are affected. As this list is affected, so are those keywords relevancy rates across categories and new articles containing those keywords are scored higher than articles without those keywords. As a result, the site's overall relevancy, in terms of content published, is increased.

In an update event, as N scores are evaluated live i.e. every time a new article is received or an editor makes a change or a visitor clicks on an article:—
1) O scores are replaced by N scores; then
2) N scores are zeroed.

FIGS. 6 and 7 show spreadsheets, which spreadsheets show a “before an O score update” and an “after an O score update” snapshot of the keyword matrix used within of any of the above systems.

The various scores are defined as follows:—
1. “O”: Original Score is defined as the probability of a particular keyword appearing within a given category. The sum of all “o” scores for a keyword across a category can be equal to 100 or 10. It is 100 when a keyword is very specific to the topic area concerned and 10 when the keyword is more generic i.e. the keyword can be found in different contexts including the topic area under consideration. As an example, within the Wine topic area, the keyword “must” relates to “a residue during the wine making process” but is also a common word. “O” scores for this keyword are therefore evaluated on base 10.
2. “A”: Appearance Count is defined as the total number of times a keyword has appeared in articles within a given category. Therefore each keyword has 4 “a” scores.
3. “C”: Click Count is defined as the number of times an article containing a given keyword has been clicked on by users of the site. Each keyword has 4 “c” scores, one for each category. The “c” score is incremented when a user clicks on an article that contains one or more instances of the keyword by 1.
4. “N”: New Score is defined as the new probability of a particular keyword appearing within a given category. “N” is evaluated using “A” and “C” scores according to the following formula:
   Where N1=New Score for a keyword in category 1
      A1=Appearance count for a keyword in category 1
      C1=Click count for a keyword in category 1
      A1→n=Appearance count for a keyword in categories 1 to n
      C1→n=Click count for a keyword in categories 1 to n

N1=A1×C1/Sum(A1→n×C1→n)×base(10 or 100)

Thus, the new score is calculated by dividing the product of “A” and “C” scores for a keyword in one category by the sum of the products of “A” and “C” scores across all categories.

In one form, the source of an article can modify the initial ranking provided; thus for example if the article was from a prestigious or academic newspaper or magazine, or from a specialist magazine, then it would score higher than a small local newspaper review. Likewise, the website activities of the users can be rated according to a rating or value or standing of the users, such that greater prominence is given to a user who is for example, a professional, an academic, a noted wine critic or expert in the relevant field, as compared to an ordinary person.

The present invention is applicable to systems for ranking blocks of data other than articles of words. For example, the present system could readily be used for a system for identifying and ranking music based, rather than on words, on beat, melodies, tempo, types of music, instruments and so on.

1-40. (canceled)

41. A method of providing, at a website, articles about a subject, the method comprising:
compiling a number of articles about a subject for viewing at a website;
using a ranking operation on the articles based on relevancy to a plurality of predetermined keywords/keyphrases;
modifying ranking values of the predetermined keywords/keyphrases by website visitor actions; and then
applying the modified values of the predetermined keywords/keyphrases to subsequent ranking operations for the website with the predetermined keywords/keyphrases.

42. A method according to claim 41 comprising:
repeating the modifying and applying steps one or more times.

43. A method according to claim 41 wherein the ranking operation further includes applying an increased rating in respect of an article, for one or more of the following elements:
The article is hosted by the website;
The article is from a pre-selected channel;
The article has a pre-selected keyword in the summary, headline, and/or URL;
The publication date of the article.

44. A method according to claim 41 wherein the ranking operation further includes boosting the ranking value by a factor comprising appearances of the predetermined keywords/keyphrases and/or clicks on an article.

45. A method according to claim 41 wherein a ranking operation includes any one or more of filtering, categorising, scoring and ranking articles.

46. A method according to claim 41 wherein a ranking value of an article is modified by interactions between a website visitor or visitors and the website.

47. A method according to claim 41, wherein a ranking value of an article is increased by a website visitor clicking on and/or viewing the article.

48. A method according to claim 41 wherein a ranking value of an article is increased by a print operation in relation to that article.

49. A method according to claim 41, wherein a ranking value of an article is increased in relation to the time duration for which a website visitor views the article.

50. A method according to claim 41, wherein a ranking value is determined according to the time spent on viewing an article, with a normalisation factor based on one or more of the following characteristics:—
The size of the article;
The number of words in the article;
The number and/or size of tables and/or Figures in the article;
A complexity co-efficient related to the article.

51. A method of supplying a newsletter comprising:
compiling a number of articles about a subject at a website;
using a ranking operation on the articles based on relevancy to a plurality of predetermined keywords/keyphrases;
modifying ranking values of the predetermined keywords/keyphrases by website visitor actions; and then
applying the modified values of the predetermined keywords/keyphrases to subsequent ranking operations for the website with the predetermined keywords/keyphrases; electronically sending out a newsletter, on the Internet or other electronic network or communication system, the newsletter including articles or summaries sorted according to the modified ranking value.

52. A method of supplying a newsletter according to claim 51 wherein the website visitor actions comprise website actions of the user for whom the newsletter is being provided.

53. A method of supplying a newsletter according to claim 51 comprising repeating the modifying and applying steps one or more times.

54. A system for providing, at a website, articles about a subject, the system comprising:
means to compile a number of articles about a subject for viewing at a website;
means to use a ranking operation on the articles based on relevancy to a plurality of predetermined keywords/keyphrases;
means to modify ranking values of the predetermined keywords/keyphrases by website visitor actions; and
means to apply the modified values of the predetermined keywords/keyphrases to subsequent ranking operations for the website with the predetermined keywords/keyphrases.

55. A system according to claim 54 comprising means to repeat the modifying and applying steps one or more times.

56. A system according to claim 54 comprising ranking means to apply an increased rating in respect of an article for one or more of the following elements:
The article is hosted by the website;
The article is from a pre-selected channel;
The article has a pre-selected keyword in the summary, headline, and/or URL;
The publication date of the article.

57. A system according to claim 54 comprising means to boost the ranking value by a factor comprising appearances of the predetermined keywords/keyphrases and/or clicks on an article.

58. A system according to claim 54 wherein a ranking operation includes any one or more of filtering, categorising, scoring and ranking articles.

59. A system according to claim 54 comprising means to modify the ranking value of an article by interactions between a website visitor and the website.
